(19) United States
(12) Patent Application Publication
(10) Pub. No.: US 2024/0094351 A1
(43) Pub. Date: Mar. 21, 2024

(54) LOW-PROFILE LIDAR SYSTEM WITH SINGLE POLYGON AND MULTIPLE OSCILLATING MIRROR SCANNERS

(71) Applicant: Innovusion, Inc., Sunnyvale, CA (US)

(72) Inventors: Yufeng Li, Milpitas, CA (US); Ching-Ling Men, Sunnyvale, CA (US); Wenxu Zhang, Newark, CA (US); Yimin Li, Cupertino, CA (US)

(73) Assignee: Innovusion, Inc., Sunnyvale, CA (US)

(21) Appl. No.: 18/234,799

(22) Filed: Aug. 16, 2023

Related U.S. Application Data
(60) Provisional application No. 63/408,444, filed on Sep. 20, 2022.

(51) Int. Cl. G01S 7/481; G01S 17/931

(52) U.S. Cl. CPC G01S 7/4817; G01S 7/4813; G01S 7/4815; G01S 17/931

(57) ABSTRACT

A low-profile LiDAR system is provided. The low-profile LiDAR system comprises a housing; a rotatable polygon mirror having a plurality of reflective facets; and a first oscillating mirror disposed laterally on one side of the rotatable polygon mirror. The first oscillating mirror is configured to direct one or more first transmission light beams to a first reflective facet of the rotatable polygon mirror. The LiDAR system may also include a second oscillating mirror disposed laterally on another side of the rotatable polygon mirror. The second oscillating mirror is configured to direct the one or more second transmission light beams to a second reflective facet. A combination of the first and second oscillating mirrors, and the rotatable polygon mirror is configured to: scan the first and second transmission light beams to a first field-of-view and a second field-of-view, respectively, and direct return light to one or more detectors.

### CROSS-REFERENCE TO RELATED APPLICATIONS

This application claims priority to U.S. Provisional Patent Application Ser. No. 63/408,444, filed Sep. 20, 2022, entitled “LOW-PROFILE LIDAR DESIGN WITH SINGLE POLYGON AND DUAL-GALVO SCANNERS,” the content of which is hereby incorporated by reference in its entirety for all purposes.

### FIELD OF THE TECHNOLOGY

This disclosure relates generally to optical scanning and, more particularly, to a low-profile light detection and ranging (LiDAR) system having a single polygon mirror and dual oscillating mirror scanners.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

A low-profile LiDAR system comprising a single rotatable polygon mirror and dual oscillating mirrors is provided in this disclosure. The oscillating mirrors can be galvanometer mirrors. In particular, by using dual oscillating mirrors and placing transmitters and receivers side-by-side with the polygon mirror and the oscillating mirrors, the overall height of the optical scanners and/or the LiDAR system can be reduced. Further, by using two oscillating mirrors positioned at two sides of the polygon mirror, the polygon mirror can rotate at a reduced speed, while producing more scanlines in the overlapping region of the FOVs. As a result, the low-profile LiDAR system disclosed can reduce the operating noise of the polygon mirror, reduce the power consumption, and improve the reliability of the polygon mirror. In the disclosed low-profile LiDAR system, each oscillating mirror, combined with the shared polygon mirror, can form a scanner to scan a respective FOV of the scanner. The combination of the multiple FOVs forms the entire FOV of the LiDAR system. The FOVs overlap in certain regions and therefore, the scan resolution in the overlapped region can be improved because scanlines are produced by multiple scanners in the overlapped region.

In one embodiment, a low-profile LiDAR system is provided. The low-profile LiDAR system comprises a housing; a rotatable polygon mirror having a plurality of reflective facets; and a first oscillating mirror disposed laterally on one side of the rotatable polygon mirror. The first oscillating mirror is configured to direct one or more first transmission light beams to a first reflective facet of the rotatable polygon mirror. The LiDAR system may also include a second oscillating mirror disposed laterally on another side of the rotatable polygon mirror. The second oscillating mirror is configured to direct the one or more second transmission light beams to a second reflective facet of the rotatable polygon mirror. The second reflective facet is different from the first reflective facet. A combination of the first oscillating mirror, the second oscillating mirror, and the rotatable polygon mirror is arranged in the housing and configured to: scan the first transmission light beams in a horizontal direction and a vertical direction to a first field-of-view, scan the second transmission light beams in a horizontal direction and a vertical direction to a second field-of-view, the second field-of-view at least partially overlapping with the first field-of-view in the horizontal direction, and direct return light formed based on the first transmission light beams and return light formed based on the second transmission light beams to one or more detectors.

In one embodiment, a method performed by a low-profile LiDAR system is provided. The method is performed by a rotatable polygon mirror having a plurality of reflective facets, a first oscillating mirror disposed laterally on one side of the rotatable polygon mirror, and a second oscillating mirror disposed laterally on another side of the rotatable polygon mirror. The method comprises directing, by the first oscillating mirror, one or more first transmission light beams to a first facet of the rotatable polygon mirror; and directing, by the second oscillating mirror, one or more second transmission light beams to a second facet of the rotatable polygon mirror. The second reflective facet being different from the first reflective facet. The method further comprises performing, by a combination of the first oscillating mirror, the second oscillating mirror, and the rotatable polygon mirror that is arranged in a housing, steps including: scanning the first transmission light beams in a horizontal direction and a vertical direction to a first field-of-view, scanning the second transmission light beams in a horizontal direction and a vertical direction to a second field-of-view, the second field-of-view partially overlapping the first field-of-view, and directing return light formed based on the first transmission light beams and return light formed based on the second transmission light beams to one or more detectors.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view.

FIG. 6 is a block diagram illustrating an example apparatus used to implement systems, apparatus, and methods in various embodiments.

FIG. 7A is a diagram illustrating a front view of a vehicle mounted with one or more LiDAR systems at least partially integrated in the vehicle roof, according to some embodiments.

FIG. 7B illustrates a side view of a vehicle and positions for mounting one or more LiDAR systems, according to some embodiments.

FIGS. 7C and 7D illustrate different embodiments of mounting at least a part of a LiDAR system to a vehicle roof.

FIG. 8 is a block diagram illustrating a LiDAR system having a vertical arrangement, according to some embodiments.

FIG. 9 is a diagram illustrating an example embodiment of a LiDAR system having laterally arranged scanners comprising a polygon mirror and dual oscillating mirrors, according to some embodiments.

FIG. 10A is a diagram illustrating an example of a portion of the LiDAR system shown in FIG. 9, and an example optical transmitting light path in accordance with some embodiments.

FIG. 10B is a diagram illustrating an example portion of the LiDAR system shown in FIG. 9, and an example optical receiving light path in accordance with some embodiments.

FIG. 10C is a diagram illustrating another example of a portion of the LiDAR system shown in FIG. 9, in accordance with some embodiments.

FIG. 11 illustrates two field-of-views scanned by multiple transmission light beams using multiple optical scanners having one polygon mirror and dual oscillation mirrors, in accordance with some embodiments.

FIG. 12 is a flowchart illustrating a method performed by a low-profile LiDAR system for scanning field-of-views, in accordance with some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first mirror could be termed a second mirror and, similarly, a second mirror could be termed a first mirror, without departing from the scope of the various described examples. The first mirror and the second mirror can both be mirrors and, in some cases, can be separate and different mirrors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Most LiDAR users (e.g., original equipment manufacturers, or OEMs) prefer a LiDAR system with a low profile for minimal intrusion when a LiDAR system is mounted on top of a vehicle. Some current LiDAR systems comprise a polygon mirror for scanning and are approaching their limit in the following aspects: (1) the height of the LiDAR system may be difficult to be further reduced further because a polygon scanner may be stacked onto the transceiver; and (2) the scanline count and density may be difficult to further improve due to strong dependence of the rotational speed of the polygon mirror. For example, a typical LiDAR system may have a height of 50-60 mm. But it may still be desired to further reduce the height to better fit into a vehicle. For instance, certain portions of a vehicle (e.g., the roof) may not have a large space to accommodate the entire height of the LiDAR system. Thus, without further reducing the height of the LiDAR system, the LiDAR system protrudes significantly outside of the vehicle. Such a protrusion may cause aerodynamic drag and thus affect the performance of the vehicle. The protrusion may also be undesirable because of optical and aesthetical reasons or vehicle integration requirements.

Further, a LiDAR system using a polygon mirror as at least a part of the optical scanner may need to rotate the polygon mirror at a high speed of more than, for example, 4800 rpm. The high rotational speed requirement is caused by the scanning requirements such as the number of scanlines per frame and the frame rate. As an example, if the scanning of the LiDAR system requires 10 Hz frame rate and 160 lines per frame. This may translate to a rotational speed requirement of about 4800 rpm or higher for a polygon mirror. If the number of scanlines increases to 200, the polygon mirror may need to rotate at about 6000 rpm or higher. A higher frame rate would also require the polygon mirror to rotate at a higher speed. The higher frame rate and higher number of scanlines may provide high scanning density, which in turn results in high resolution LiDAR images. However, the increasing of the rotational speed of the polygon mirror also may cause overheating, an increased operating noise level, reduced reliability, and higher power consumption. Thus, it is desired to have a low-profile LiDAR system with reduced polygon mirror rotational speed.

In this disclosure, a low-profile LiDAR system is provided. The LiDAR system comprises a single rotatable polygon mirror and dual oscillating mirrors for mitigating or eliminating the above-described problems. The oscillating mirrors can be galvanometer scanners. In particular, by using dual oscillating mirrors and placing the transmitters and receivers side-by-side with the polygon mirror and the oscillating mirrors, the overall height of the optical scanners and/or the LiDAR system can be reduced to, for example, less than 40 mm. Further, by using two oscillating mirrors positioned at two sides of the polygon mirror, the polygon mirror can rotate at a reduced speed, while producing more scanlines together in certain regions (e.g., a region of interest (ROI)). Each oscillating mirror, combined with the shared polygon mirror, can form an optical scanner to facilitate scanning of a respective FOV of the scanner. The combination of the multiple FOVs forms the entire FOV of the LiDAR system. An FOV comprises a horizontal component and a vertical component. The horizontal component is also referred to as the horizontal FOV and is a field-of-view in the horizontal direction. The vertical component of an FOV is also referred to as the vertical FOV and is the field-of-view in the vertical direction. The horizontal direction can be the direction substantially parallel to the road surface of the vehicle to which the LiDAR system is mounted. The vertical direction can be the direction substantially perpendicular to the road surface of the vehicle to which the LiDAR system is mounted. It is understood that the horizontal direction and the vertical direction are relative and can be other directions depending on the orientation of the LiDAR system, as long as they are perpendicular to each other.

Embodiments of present invention are described below. In various embodiments of the present invention, a low-profile LiDAR system comprises a housing; a rotatable polygon mirror having a plurality of reflective facets; and a first oscillating mirror disposed laterally on one side of the rotatable polygon mirror. The first oscillating mirror is configured to direct one or more first transmission light beams to a first reflective facet of the rotatable polygon mirror. The LiDAR system may also include a second oscillating mirror disposed laterally on another side of the rotatable polygon mirror. The second oscillating mirror is configured to direct the one or more second transmission light beams to a second reflective facet of the rotatable polygon mirror. The second reflective facet is different from the first reflective facet. A combination of the first oscillating mirror, the second oscillating mirror, and the rotatable polygon mirror is arranged in the housing and configured to: scan the first transmission light beams in a horizontal direction and a vertical direction to a first field-of-view, scan the second transmission light beams in a horizontal direction and a vertical direction to a second field-of-view, the second field-of-view at least partially overlapping with the first field-of-view in the horizontal direction, and direct return light formed based on the first transmission light beams and return light formed based on the second transmission light beams to one or more detectors.

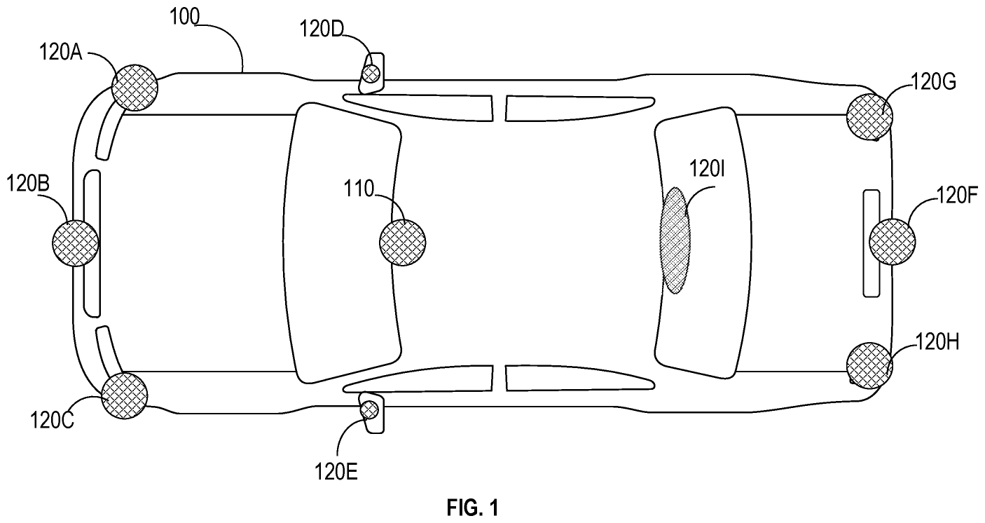

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

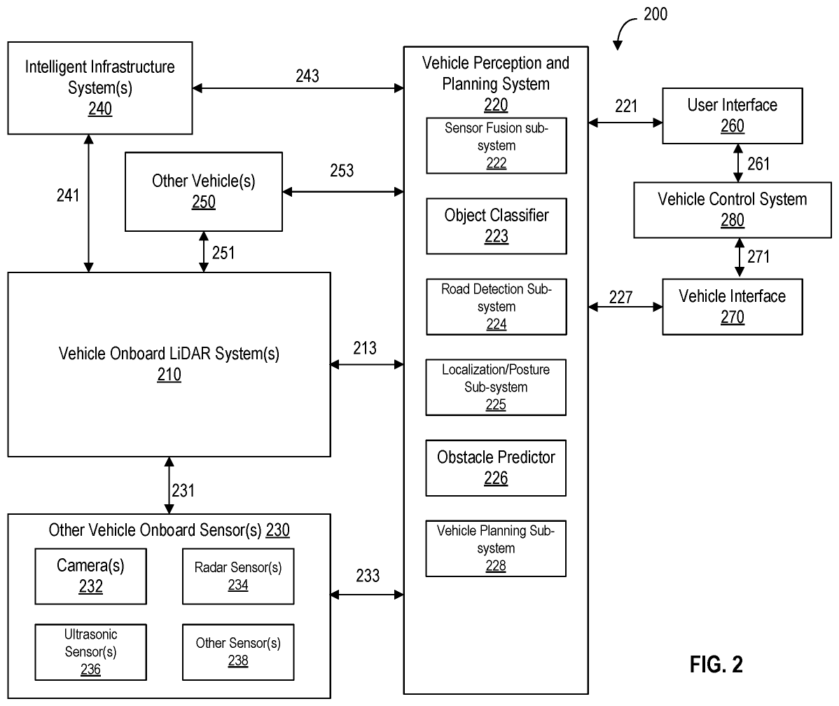

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any locations (e.g., rear-view mirrors, pillars, front grille, and/or back bumpers, etc.).

Other vehicle onboard sensors(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

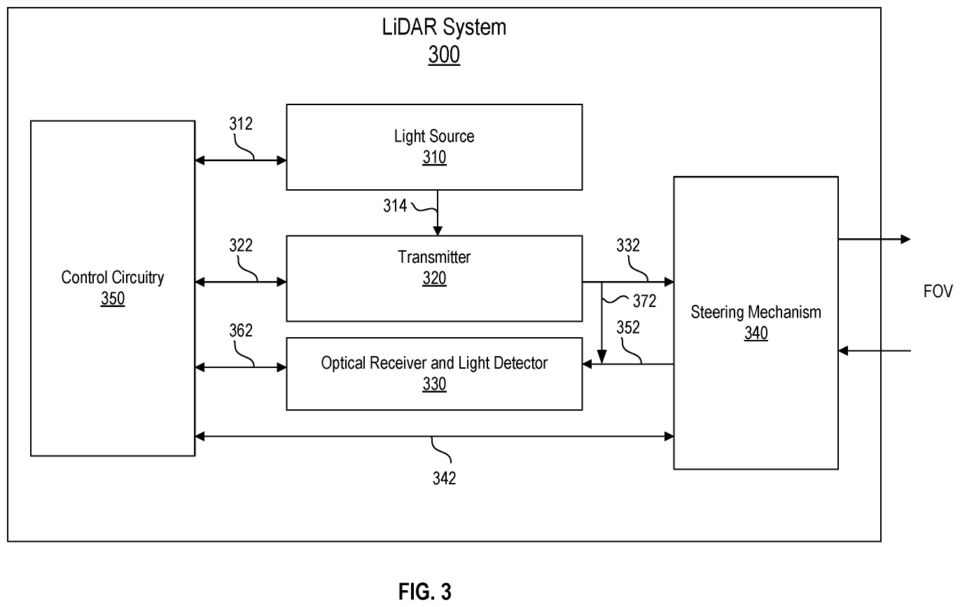

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

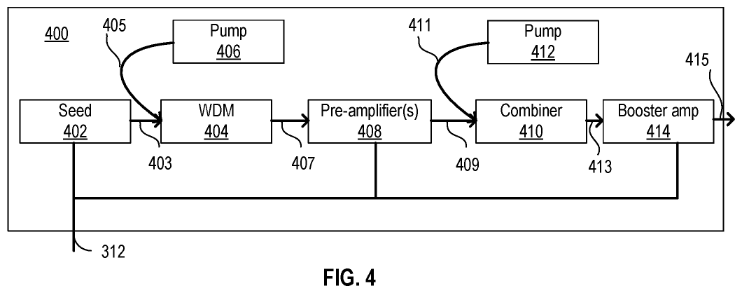

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon, or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

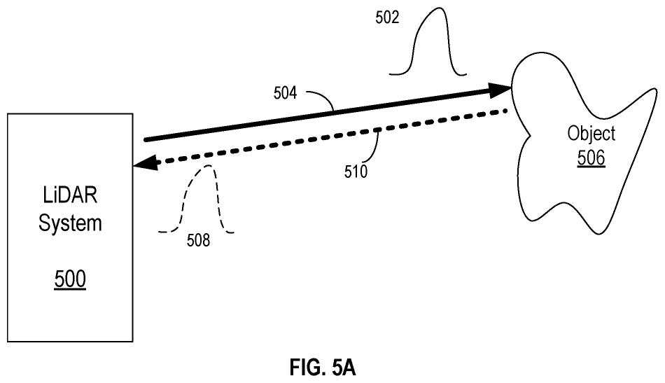

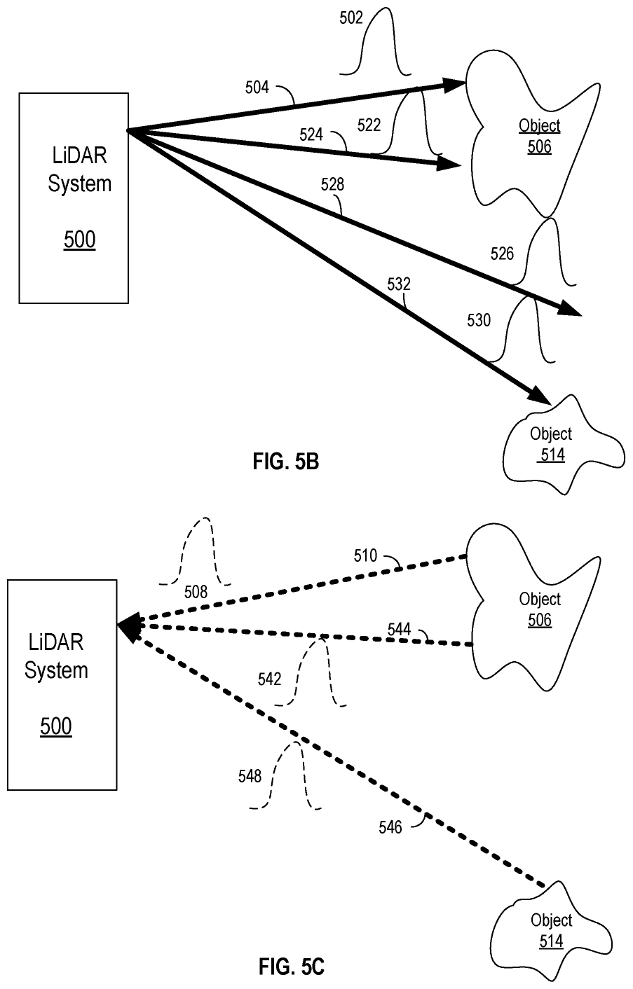

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-12, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

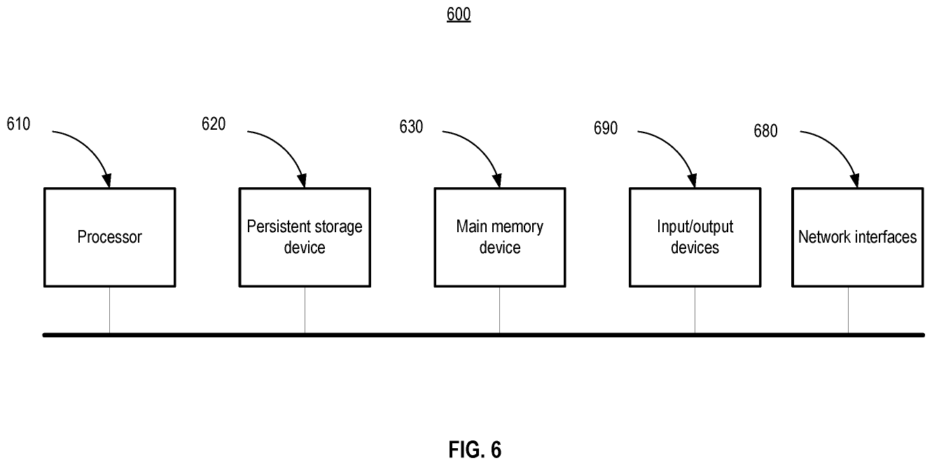

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-12 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-12. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

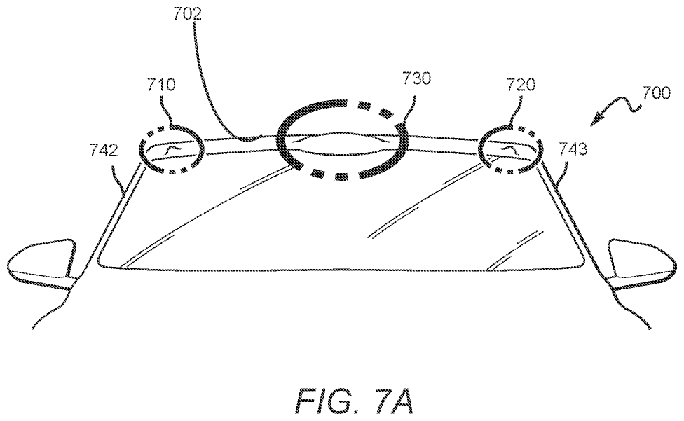

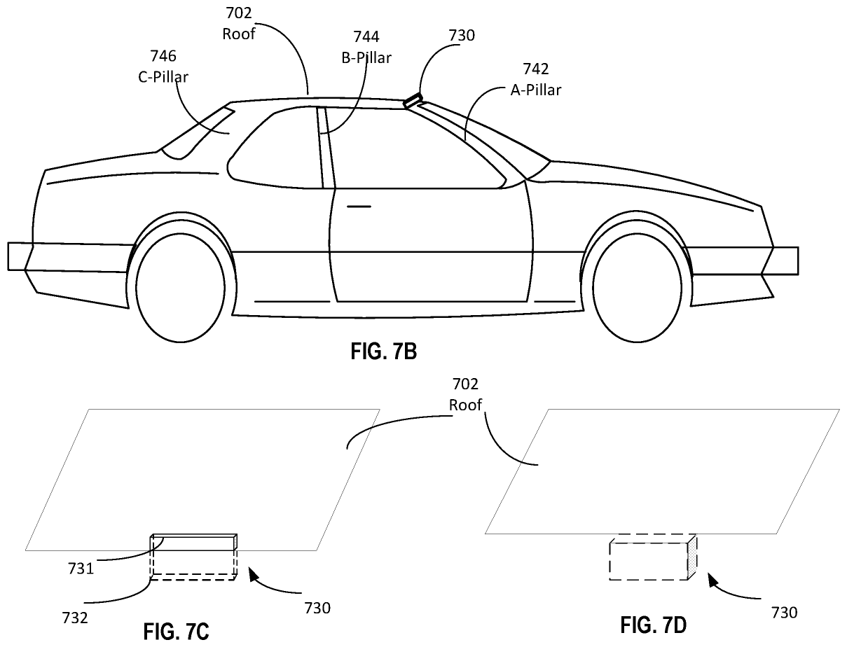

FIG. 7A is a diagram illustrating a front view of a vehicle 700 mounted with one or more LiDAR systems that are at least partially integrated in the vehicle roof, according to some embodiments. A LiDAR system can be mounted to, or integrated with, a moveable platform. A moveable platform comprises one or more of a vehicle, a robot, an unmanned aviation vehicle (UAV), roller skates, a skateboard, a scooter, a bicycle, a tricycle, an aircraft, a watercraft, or a spacecraft. The below descriptions use a vehicle for illustration but can be applied in principle to other moveable platforms. FIG. 7A is a diagram illustrating a front view of a vehicle 700 mounted with one or more LiDAR systems 710, 720, and 730. In some examples, the systems 710, 720, and 730 shown in FIGS. 7A-7D are portions of LiDAR systems. For example, they may include the optical scanner, transmitter, and receiver, but do not include other components of the LiDAR system. In some examples, systems 710, 720, and 730 shown in FIGS. 7A-7D represent entire LiDAR systems. For the purpose of simplicity, systems 710, 720, and 730 are referred to as LiDAR systems, either partial systems or entire systems. The LiDAR systems 710, 720, and 730 are at least partially integrated in the vehicle roof 702, according to some embodiments. FIG. 7B illustrates a side view of a vehicle 700 and positions for mounting one or more LiDAR systems, according to some embodiments. FIGS. 7C and 7D illustrate different embodiments of mounting at least a part of a LiDAR system to a vehicle roof 702.

With reference to FIGS. 7A-7C, a LiDAR system may be positioned at different locations of the vehicle 700, such as two corner positions located at the left and right sides of the vehicle 700, or a center position. In this disclosure, LiDAR system 730 located at the center of the vehicle roof is used as a main illustrative example. But the concept can also be applied to LiDAR systems 710, 720, or any other systems located at any positions of a moveable platform. A LiDAR system, as described above, may include many components such as a light source, a transmitter, a steering mechanism, an optical receiver, etc. In some embodiments disclosure herein, certain components of the LiDAR system may be assembled together to form an optical core assembly including at least a rotatable polygon mirror. It may also include other optics such as one or more oscillating mirrors, transmitters, and receivers. Embodiments of an optical core assembly comprising a polygon mirror and two oscillating mirrors are described in more detail below. FIGS. 7A-7D are described using an optical core assembly as an example of a part of a LiDAR system. But it is understood that other components of the LiDAR scanning system may also be disposed at different locations of the vehicle 700, including those positions shown in FIGS. 7A-7C.

As shown in FIGS. 7A-7B, optical core assemblies of LiDAR systems 710 and 720 can be positioned proximate to one or more pillars of the vehicle roof 700. For instance, optical core assemblies of LiDAR systems 710 and 720 may be disposed at the vehicle roof 702 proximate to A-pillar 742, B-pillar 744, C-pillar 746, or another pillar (e.g., D-pillar if a vehicle has one). Each optical core assemblies of LiDAR systems 710 and 720 includes, for example, an enclosure and a rotatable polygon mirror. It may also include one or more oscillating mirrors, transmitters, and/or receivers. In some embodiments, one or more pillars of the vehicle roof 702 may include first and second complementary pillars located at the two sides of the vehicle 700. And one or more optical core assemblies may be positioned proximate to the complementary pillars. As shown in FIG. 7A, a first optical core assembly of LiDAR system 710 may be positioned proximate to A-pillar 742 at the right side of vehicle 700, and a second optical core assembly of LiDAR system 720 may be positioned proximate to a complementary A-pillar 743 on the left side of the vehicle 700. Also as shown in FIG. 7A, another optical core assembly of LiDAR system 730 may be positioned approximately equidistant between the two complementary A-pillars 742 and 743. For example, the optical core assembly of LiDAR system 730 can be positioned at a center location on roof 702, which may be the maximum elevation position of vehicle 700.

In some embodiments, an optical core assembly of a LiDAR system can be at least partially integrated with the vehicle roof. As one example shown in FIG. 7C, at least a portion 731 or a side surface of the optical core assembly of LiDAR system 730 protrudes outside of the vehicle roof 702 to facilitate scanning of light. As described below in greater detail, the optical core assembly of LiDAR system 730 can be configured to reduce or minimize the overall height or at least the height of the portion 731 that protrudes outside of the vehicle roof 702, thereby reducing the aerodynamic impact to the vehicle 700, to improve the aerodynamic and aesthetical aspects of the vehicle 700, and to facilitate better integration of the LiDAR system into vehicle 700. As another example shown in FIG. 7D, the optical core assembly of LiDAR system 730 may be fully embedded or integrated inside the vehicle underneath the vehicle roof 702, such that there is no or minimum impact to the aerodynamic performance of the vehicle. FIGS. 7B and 7C illustrate that in some examples, the vehicle roof 702 (or any moveable platform) has planar surface. The planar surface can have a substantially horizontal profile (e.g., a horizontal profile substantially parallel to a road surface). In some examples, the roof 702 may have a complex surface profile. For instance, roof 702 may have a substantially flat surface in the middle portion but curved surfaces toward front and back of the vehicle. Roof 702 also may have a complex surface profile to accommodate, for example, a sliding window, a roll bar or halo, etc.

With reference back to FIG. 7A, in some embodiments, optical core assemblies of LiDAR systems 710, 720, and 730 may have different FOVs. The different FOVs may be overlapping FOVs in the front direction for full coverage and for redundancy. In one example, LiDAR system 730, as described below, may use a single polygon mirror and dual oscillating mirrors, thereby itself scanning two overlapping FOVs. For instance, the overlapping may be about 40 degrees. In one embodiment, the two FOVs scanned by LiDAR systems 710 and 720 may overlap by about 10-60 degrees. One or more LiDAR systems 710 and 720 may have a large horizontal FOV to provide both side and front detection coverage. For example, the one or more LiDAR systems 710 and 720 can be configured to have at least a 120° FOV in the horizontal direction and/or at least 25° FOV in the vertical direction. In one embodiment, LiDAR systems 710 and 720 are configured to detect objects located at a 200-meter or 250-meter distance (or more) with a 10% reflection rate. In another embodiments, the LiDAR system 730 may be configured to detect objects in a far distance (e.g., more than 200 meters) and the LiDAR systems 710 and/or 720 are configured to detect objects in a near distance (e.g., up to 50 meters). It is understood that the multiple LiDAR systems can be configured in any desired manner to scan any number of FOVs surrounding the vehicle 700. In addition, with reference to FIGS. 7A-7C, similar to described above with respect to LiDAR system 730, LiDAR system 710 and 720 can be configured to have a minimal vertical height to reduce aerodynamic drag. For instance, the vertical height can be configured to be less than 40 mm by using a similar lateral arrangement described below.

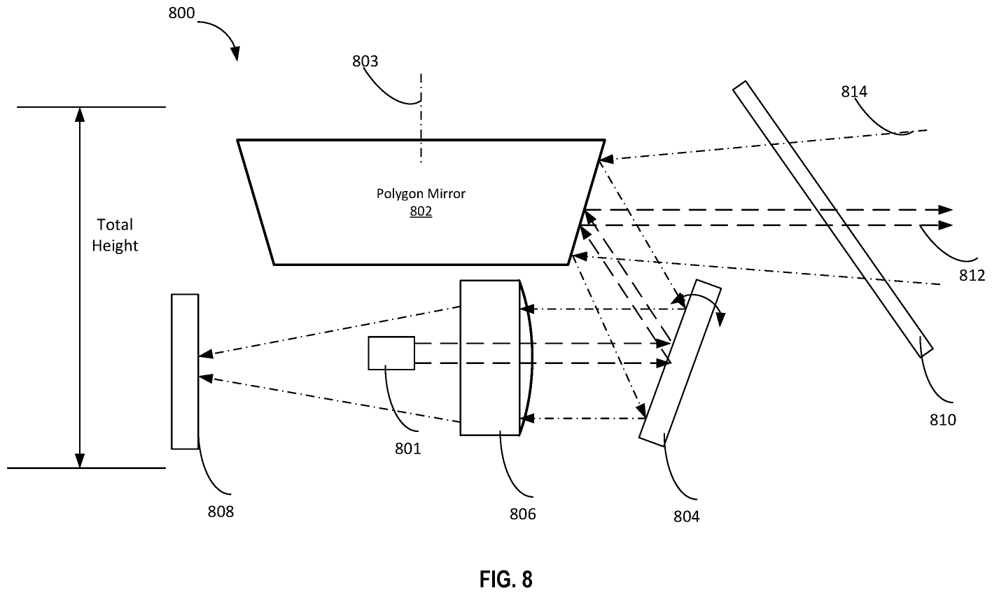

FIG. 8 is a block diagram illustrating a LiDAR system 800 having a vertical arrangement according to some embodiments. As illustrated in FIG. 8, LiDAR system 800 includes transmitter 801, polygon mirror 802, oscillating mirror 804, collection lens 806, a receiver 808, and a window 810. Transmitter 801 includes one or more light sources (e.g., laser diodes, fiber-based laser, etc.) and one or more transmitter optics (e.g., collimation lens, folding mirror(s), lens, etc.). Transmitter 801 provides one or more transmission light beams 812, which are directed to an optical scanner for scanning a field-of-view (FOV) of the LiDAR system 800. In one embodiment, the optical scanner includes an oscillating mirror 804 and a polygon mirror 802. Oscillating mirror 804 receives the one or more transmission light beams 812 and redirect the beams to polygon mirror 802. Oscillating mirror 804 can oscillate to facilitating scanning of the transmission light beams 812 in one direction (e.g., the vertical direction). Light beams 812 are directed from oscillating mirror 804 to polygon mirror 802, which include a plurality of reflective facets and is rotatable about an axis 803. Polygon mirror 802 rotates to scan the transmission light beams 812 in another direction (e.g., the horizontal direction). The light beams 812 can be directed from polygon mirror 802 to an FOV of the external environment through a window 810 of the LiDAR system 800.

As also illustrated in FIG. 8, when transmission light beams 812 are scanned to the FOV of LiDAR system 800, return light 814 may be formed from reflecting or scattering of beams 812 by objects in the FOV (not shown in FIG. 8). Return light 814 can be received by polygon mirror 802, which redirects the return light 814 to oscillating mirror 804. Oscillating mirror 804 directs the return light 814 to, for example, a collection lens 806, which focuses return light 814 to a receiver 808. Receiver 808 may include one or more sensors or detectors for detecting the return light 814 and converting it to electrical signals for further processing such as generating a point cloud.

The configuration shown in FIG. 8 is referred to as a vertically arranged (or vertically stacked) configuration, because at least a part of the optical scanner (including polygon mirror 802 and oscillating mirror 804) and/or at least a part of the transmitter and receiver are arranged in a vertical direction. In FIG. 8, the polygon mirror 802 is arranged vertically above the oscillating mirror 804, the transmitter 801, the receiver 808, and/or other optics. In other configurations, the polygon mirror 802 can be arranged vertically below oscillating mirror 804, the transmitter 801, the receiver 808, and/or other optics. It is understood that other vertical arrangements may also be used by rearranging the components of LiDAR system 800. These types of vertical arrangements of a LiDAR system may have a total height of about, for example, 50-60 mm or more. While this type of height may fit into many moveable platforms like a vehicle, it is desirable to have a further reduced height such that the LiDAR system has a low profile.

A low-profile LiDAR system can be more easily mounted to, or integrated with, certain parts of a moveable platform. For instance, a low-profile LiDAR system can be mounted to, or integrated with, the roof of a vehicle (e.g., as system 730 mounted to roof 702 of vehicle 700) shown in FIG. 7A). The roof of a vehicle is typically thin compared to other part of the vehicle. Therefore, a low-profile LiDAR system integrated in the roof of a vehicle reduces aerodynamic drag and improves the aesthetics aspects of the vehicle. Further, it is also desirable for a LiDAR system to improve the scanline density (and thereby scan resolution) for at least certain areas of the LiDAR system's FOV such as a region of interest (ROI). Moreover, because a LiDAR system is oftentimes used in a moveable platform such as a vehicle, improving the reliability of the polygon mirror to extend the LiDAR's lifetime is desirable too. As described in more detail below, the embodiments of a low-profile LiDAR system described herein can also reduce the rotatable speed of the polygon mirror such that it improves the reliability and life span of the polygon mirror.

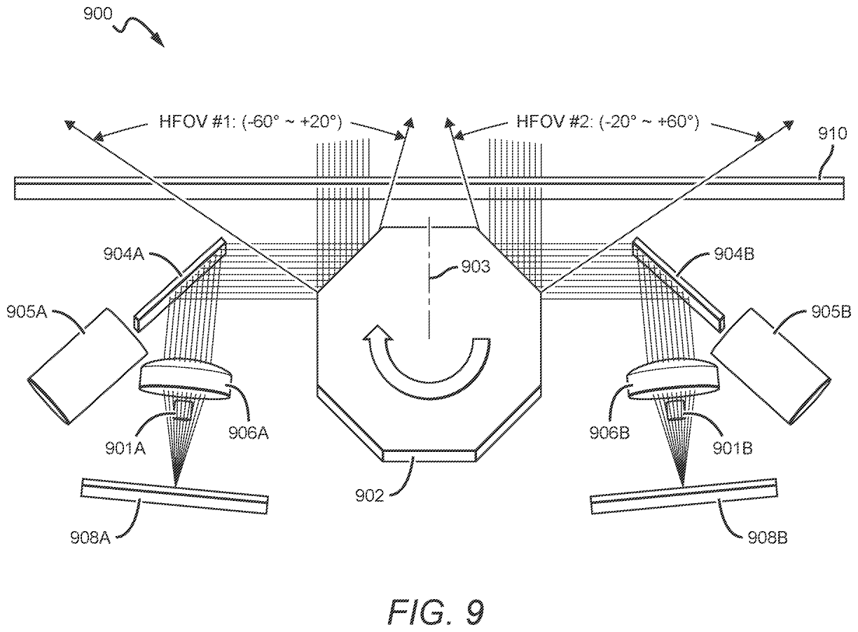

FIG. 9 is a diagram illustrating an example embodiment of a low-profile LiDAR system 900 having an optical scanner with a polygon mirror and dual oscillating mirrors, according to some embodiments. System 900 includes a rotatable polygon mirror 902, a first oscillating mirror 904A, a second oscillating mirror 904B, a first transmitter 901A, a second transmitter 901B, a first receiver 908A, and a second receiver 908B. Rotatable polygon mirror 902 includes a plurality of reflective facets for reflecting light. In FIG. 9, the polygon mirror 902 is depicted to have eight reflective facets. It is also understood that polygon mirror 902 can also have other number of reflective facets like four, five, six, seven, nine, etc. In general, the total number of scanlines per second for each scan of a LiDAR system is proportional to the multiplication of the rotational speed of the polygon mirror and the number of reflective facets. Thus, increasing the number of reflective facets may increase the total number of scanlines per second, and thus the scan resolution. If the total number of scanlines is fixed, increasing the number of reflective facets can reduce the rotational speed of the polygon mirror. Reducing the rotational speed can reduce noise generated by the polygon mirror, reduce power consumption, and improve reliability and life span of the polygon mirror.

In the embodiment of LiDAR system 900 shown in FIG. 9, first oscillating mirror 904A and second oscillating mirror 904B are both disposed laterally (compared to the vertically disposed mirror 804 in FIG. 8) with respect to polygon mirror 902. FIG. 9 illustrates that mirror 904A is disposed laterally on one side of polygon mirror 902 and mirror 904B is disposed laterally on another side of polygon mirror 902. Lateral arrangements of the oscillating mirrors 904A and 904B place the mirrors at approximately the same vertical position as that of the polygon mirror 902, thereby reducing the overall height of the LiDAR system 900 shown in FIG. 9. The mirrors 904A and 904B are configured to receive transmission light beams provided by transmitter 901A and 901B, respectively. They are further configured to direct their received respective transmission light beams to polygon mirror 902 disposed between the two mirrors 904A and 904B. Oscillating mirrors 904A and 904B can each oscillate about a respective axis (e.g., an axis along the longitudinal direction of a mirror). The oscillation movements of the oscillating mirrors 904A and 904B are enabled by motors 905A and 905B, respectively, and/or other mechanical and electrical components (e.g., one or more controllers). In some embodiments, the oscillating mirrors 904A and 904B are galvanometer mirrors comprising encoders for sensing the mirrors' angular positions.

In the embodiment shown in FIG. 9, first oscillating mirror 904A and second oscillating mirror 904B are positioned such that they direct their respective transmission light beams to two different reflective facets of polygon mirror 902. The two different reflective facets may or may not be adjacent to each other, depending on the total number of reflective facets of polygon mirror 902 and/or the angular position of the polygon mirror 902 at any given time when the polygon mirror 902 rotates.

In FIG. 9, polygon mirror 902 is configured to scan the respective transmission light beams received from the first oscillating mirror 904A and second oscillating mirror 904B to their respective FOVs. In particular, the combination of first oscillating mirror 904A and polygon mirror 902 enables scanning a first FOV; and the combination of second oscillating mirror 904B and polygon mirror 902 enables scanning a second FOV. Each FOV has a horizontal dimension and a vertical dimension. In one embodiment, polygon mirror 902 scans the transmission light beams in the horizontal direction. The two oscillating mirrors 904A and 904B scan respective transmission light beams in the vertical direction. Correspondingly, each FOV has a horizontal dimension denoted by HFOV and a vertical dimension denoted by VFOV. As shown in FIG. 9, in one example, the combination of first oscillating mirror 904A and polygon mirror 902 can be configured to scan the first transmission light beams (received from the first transmitter 901A) across of a first FOV horizontally from approximately −60 degrees to +20 degrees (e.g., denoted by HFOV #1 in FIG. 9). Similarly, the combination of second oscillating mirror 904B and polygon mirror 902 can be configured to scan the second transmission light beams (received from the second transmitter 901B) across of a second FOV horizontally from approximately −20 degrees to +60 degrees (e.g., denoted by HFOV #2 in FIG. 9). In the horizontal direction, the zero degrees corresponds to the front direction or the LiDAR system's forward moving direction. Thus, in the above example, each of the first and second FOVs has a horizontal dimension of approximately 80 degrees.

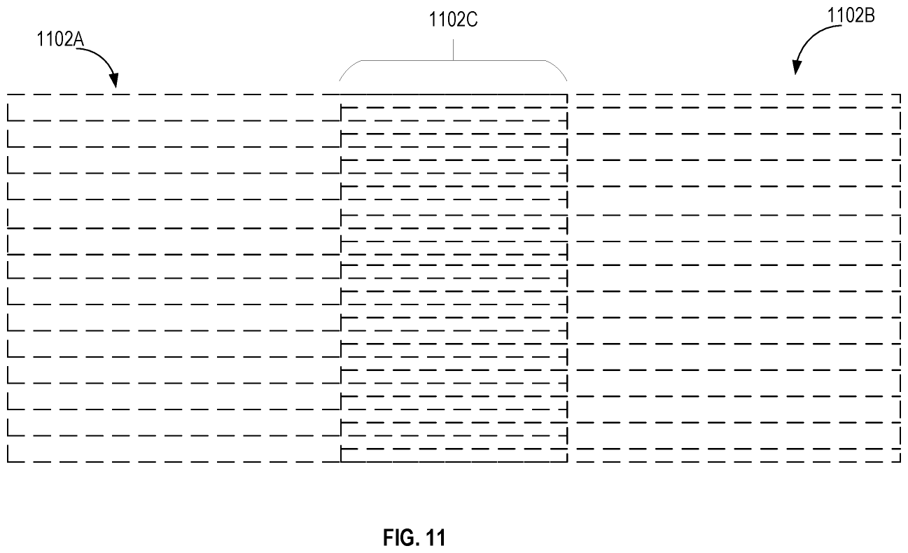

With reference still to FIG. 9, in one example, the lateral positions of the first oscillating mirror 904A, the second oscillating mirror 904B, and the rotatable polygon mirror 902 are arranged such that the first field-of-view and the second field-of-view overlap by approximately 40 degrees horizontally (e.g., the HFOV #1 and HFOV #2 overlap from −20 degrees to +20 degrees). It is understood that the overlapping between the first FOV and the second FOV in the horizontal direction can be adjusted or configured to any desired numbers by proper positioning of the oscillating mirrors and the polygon mirror, and/or by configuring the polygon mirrors characteristics like the number of facets, the sizes of the facets, etc. The overlapping region between the first FOV and the second FOV can be beneficial, as described below using FIG. 11.

FIG. 11 illustrates two FOVs 1102A and 1102B scanned by respective transmission light beams using an optical scanner having one polygon mirror 902 and dual oscillation mirrors 904A and 904B shown in FIG. 9. The two FOVs 1102A and 1102B overlap horizontally to form an overlapped region 1102C. With reference to both FIG. 9 and FIG. 11, the combination of first oscillating mirror 904A and polygon mirror 902 is configured to scan FOV 1102A; and the combination of second oscillating mirror 904B and polygon mirror 902 is configured to scan FOV 1102B. For scanning FOVs 1102A and 1102B, one or more transmission light beams are directed by polygon mirror 902 from mirrors 904A and 904B to the respective FOVs. The first oscillating mirror 904A and second oscillating mirror 904B can be positioned and/or configured to scan the respective transmission light beams such that the scanlines within region 1102C are interleaved, as shown in FIG. 11. For example, the angular positions and/or oscillating speeds of mirrors 904A and 904B can be controlled so that the scanlines within region 1102C interleave.

Interleaving of the scanlines increases the scanline density in the overlapping region 1102C, and in turn increases the scan resolution. A higher scan resolution is oftentimes desirable in a region of interest (ROI), in which there may be many objects, and/or high priority objects, to be detected by the LiDAR system. Thus, LiDAR system 900 can be configured and/or positioned such that region 1102C corresponds to an ROI. It is understood that the LiDAR system 900 in FIG. 9 can be configured in any manner such that the overlapping region 1102C corresponds to a desired ROI of the LiDAR system. For instance, in FIG. 9, the two oscillating mirrors 904A and 904B are disposed symmetrically on two sides of polygon mirror 902, thereby creating the overlapping region in the forefront direction, with the overlapping region being symmetrically distributed between −20 degrees to 20 degrees. This overlapping region may correspond to an ROI in the forward moving direction of a vehicle (e.g., if the LiDAR system 900 is mounted to the front center position of a roof of the vehicle). If the ROI is in another region, the relative positions of two oscillating mirrors 904A and 904B and polygon mirror 902 can be changed (e.g., oscillating mirrors moved to left or right, positioned asymmetrically, etc.) such that the overlapping region corresponds to the ROI.

As described above, in some examples, oscillating mirrors 904A and 904B are configured to scan transmission light beams in the vertical direction. FIG. 11 illustrates that the oscillating mirrors 904A and 904B are configured such that the vertical dimensions of the first and second FOVs are substantially the same. For example, the first and second FOVs may both have a vertical dimension of approximately 30-50 degrees. In some other examples, the vertical dimension may be different between the two FOVs. For instance, oscillating mirror 904A may be configured to oscillate within a smaller vertical range compared to that of the oscillating mirror 904B.

With reference back to FIG. 9, first and second transmission light beams (not shown in FIG. 9) provided by transmitters 901A and 901B respectively are scanned by polygon mirror 902 to the first FOV and the second FOV, with an overlapping region in between. Return light may be formed by reflecting or scattering the first and second transmission light beams from objects located in the first and/or second FOVs. The return light formed by objects located in the first FOV (e.g., the FOV that has a horizontal dimension of −60 degrees to +20 degrees) is received by a first reflective facet of polygon mirror 902 and directed to oscillating mirror 904A. Similarly, the return light formed by objects located in the second FOV (e.g., the FOV that has a horizontal dimension of −20 degrees to +60 degrees) is received by a second reflective facet of polygon mirror 902 and directed to oscillating mirror 904B. The first and second reflective facets are different facets and they may or may not be adjacent to each other.

The return light formed based on the first transmission light beams is further directed by oscillating mirror 904A to a collection lens 906A, which focuses the received return light to a receiver 908A. The receiver 908A comprises one or more detectors configured to detect the return light and convert it to electrical signals for further processing (e.g., for generating the point cloud data). Similarly, the return light formed based on the second transmission light beams is further directed by oscillating mirror 904B to a collection lens 906B, which focuses the return light to a receiver 908B. The receiver 908B comprise one or more detectors configured to detect the return light and convert it to electrical signals for further processing (e.g., for generating the point cloud data). As a result, the combination of the oscillating mirror 904A, the oscillating mirror 904B, and the rotatable polygon mirror 902 is configured to both scan the transmission light beams provided by transmitters 901A and 901B to the two FOVs, and direct return light to the receivers 908A and 908B. In some examples, the combination of the oscillating mirror 904A, the oscillating mirror 904B, and the rotatable polygon mirror 902 is arranged in the same housing or enclosure (not shown).

In one embodiment, the transmitters 901A and 901B, the collection lenses 906A and 906B, and receiver 908A and 908B can also be arranged laterally with respect to polygon 902, and/or with respect to one another. In this manner, the entire height of the LiDAR system 900 can be reduced. In one example, the height of the polygon mirror 902 may be the largest among of the heights of other components like the transmitters 901A and 901B, the collection lenses 906A and 906B, and receiver 908A and 908B. Thus, the overall height of the LiDAR system 900 may be limited only by the height of the polygon mirror 902 and/or the housing of these components. In one example, the overall height of the LiDAR system 900 can be reduced to no more than 40 mm, making it easier to be mounted to a vehicle roof. It is understood that the overall height of the LiDAR system 900 may be limited by other components like the oscillating mirrors, collection lens, receivers, transmitters, and/or the housing of the LiDAR system, either individually or in combination.

In some embodiments, the plurality of reflective facets of the rotatable polygon mirror 902 are substantially parallel to the rotational axis 903 of the rotatable polygon mirror 902. The rotational axis 903 of polygon mirror 902 shown in FIG. 9 is along the direction that is perpendicular to the top surface of the polygon mirror 902. In one example, rotational axis 903 is located at the center point of polygon mirror 902 such that it is equidistant to all edges of the top surface of the polygon mirror 902. As described above, the first and second oscillating mirrors 904A and 904B are both disposed laterally on two sides of polygon mirror 902. As a result, the oscillating mirrors 904A and 904B are vertically positioned at about the same height as polygon mirror 902, for directing respective transmission light beams from the transmitters 901A and 901B to respective facets of polygon mirror 902. In one example, for receiving the transmission light beams, the reflective facets of polygon mirror 902 are configured to be parallel to the rotational axis 903 of the polygon mirror 902. In other words, each of the tilt angles of the reflective facets of polygon mirror 902 is approximately 90 degrees. A tilt angle of a reflective facet is the angle between the normal direction of the surface of the reflective facet and the rotational axis of the polygon mirror. In comparison, the tilt angles of reflective facets of polygon mirror 802 shown in FIG. 8 are not 90 degrees. The polygon mirror 802 is thus also referred to as a wedged polygon mirror because the reflective facets are not parallel to its rotational axis. As described above, LiDAR system 800 uses a vertically arranged configuration such that the transmission light beams are directed by the oscillating mirror 804 upward to the polygon mirror 802. As a result, the polygon mirror 802 need to have non-90 degrees tilt angles for receiving the light beams. But LiDAR system 900 uses a laterally arranged configuration so the facets of polygon mirror 902 can have 90-degree tilt angles. As described above and below in more detail, the return light to the LiDAR system (system 800 or 900) is directed by the polygon mirror to the oscillating mirror in both the vertically-arranged configuration (FIG. 8) and the laterally-arranged configuration (FIG. 9).

With reference back to FIG. 9, a rotational speed of the rotatable polygon mirror 902 is configured based at least on the total number of the plurality of reflective facets of the rotatable polygon mirror 902 and a scan density requirement associated with at least one of the first field-of-view, the second field-of-view, or an area of overlapping between the first field-of-view and the second field-of-view. In a LiDAR system configuration having one polygon mirror and one or more oscillating mirrors, the polygon mirror may be configured to scan horizontally and the one or more oscillating mirrors may be configured to scan vertically. Based on the scanning, the LiDAR system obtains many scanlines. Each scanline comprises many scanning points. The scanning points collectively form a point cloud representing the external environment. All scanlines from one scan of the FOV form one frame. The point density of the frame comprises a vertical point density and a horizontal point density.

In some embodiments, the total number of scanlines per second that a LiDAR system can provide is related to the multiplication of the rotational speed of a polygon mirror and the total number of reflective facets of the polygon mirror. Thus, increasing the number of facets of the polygon mirror can: (1) increase the total number of scanlines per second (if the rotational speed of the polygon mirror is fixed); or (2) reduce the rotational speed of the polygon mirror (if the total number of scanlines per second is fixed). Further, a LiDAR system (e.g., system 800 or 900) may include multiple channels to increase the number of scanlines per second. Each channel may comprise a transmitter and a receiver, and optionally optics. In some examples, multiple channels may share transmitter(s), receiver(s), and optics. Each channel may provide a transmission light beam. Multiple channels can thus transmit multiple light beams substantially simultaneously.

In one example, a LiDAR system has four channels, and therefore four transmission light beams are provided. The four transmission light beams are directed to an oscillating mirror, which redirects them to a polygon mirror. Assuming the scanning requirement for the LiDAR system is 200 scanlines per frame with a 10 Hz frame rate (i.e., 10 frames per second), the total number scanlines per second is about 2000. Thus, if a polygon mirror has five facets and four channels are used, each channel, using its transmission light beam, should provide about 500 scanlines per second. For a 5-facet polygon mirror, the polygon mirror needs to rotate at a speed of about 6000 rpm (i.e., about 100 rounds per second). In contrast, if a polygon mirror has 8 facets and four channels are used, each channel still provides about 500 scanlines per second. But for an eight-facet polygon, the polygon mirror can rotate at a reduced speed of about 3750 rpm (i.e., about 62.5 rounds per second). Accordingly, increasing the number of reflective facets can facilitate reducing the polygon mirror's rotation speed. Reducing the polygon mirror's rotational speed can reduce noise and power consumption, and improve the reliability.

In some embodiments, the horizontal point density of a LiDAR system is controlled by the polygon mirror's rotational speed and the light pulse repetition rate. A higher light pulse repetition rate can increase the horizontal point density. But a high light pulse repetition rate may also reduce the LiDAR's detection range. Reducing the polygon mirror's rotation speed, on the other hand, can increase the horizontal point density without affecting the detection range.

In addition to increasing the number of facets of the polygon mirror, the polygon mirror rotational speed can be further reduced by using more than one oscillating mirror, such as the LiDAR system 900 shown in FIG. 9. As described above, system 900 has two oscillating mirrors 904A and 904B distributed laterally at the two sides of the polygon mirror 902. In the example of system 900, oscillating mirror 904A and polygon mirror 902 form a first scanner that scans a first FOV. Oscillating mirror 904B and polygon mirror 902 form a second scanner that scans a second FOV. In one example, the first FOV and the second FOV each has a horizontal dimension of about 80 degrees, while having an overlapping scanning region. As shown in FIG. 11, the overlapping region has scanlines from both the first scanner and the second scanner, thus can effectively double, or significantly increase, the point density in both the horizontal and vertical directions. As a result, if the requirement for the number of scanlines remains the same (at least for the overlapping region), the rotational speed of the polygon mirror 902 can be reduced significantly compared to that of the polygon mirror 802. Using the same example as above, if the total number of 200 scanlines per frame is required, polygon mirror 802 (which scans with one oscillating mirror 804) has to rotate around 6000 rpm, while polygon mirror 902 (which scans with two oscillating mirrors 904A and 904B) only needs to rotate approximately 1875 rpm for obtaining the same number of scanlines within the overlapping region (see FIG. 11 for example). As described above, the overlapping region between the two FOVs can be set to correspond to a region of interest (ROI), for which high resolution scanning may be desired. In general, because of using more than one oscillating mirror, the rotational speed of the rotatable polygon mirror 902 can be configured to be much less than the rotational speed of the rotatable polygon mirror 802, which operates with one oscillating mirror.

With continued reference to FIG. 9, oscillating mirrors 904A and 904B can be independently or synchronously controlled. As described above, motor 905A and 905B can be used to provide power to move the mirrors 904A and 904B, respectively. They can be further controlled by a controller (e.g., control circuitry 350 shown in FIG. 3). The controller can be programmed to control the movement of the oscillating mirrors 904A and 904B to have any desired movement profiles to meet the scan requirements. For example, they can be controlled to be synchronized for doubling the scanlines within an ROI. They can also be controlled independently to scan two different FOVs without having to be synchronized to each other.

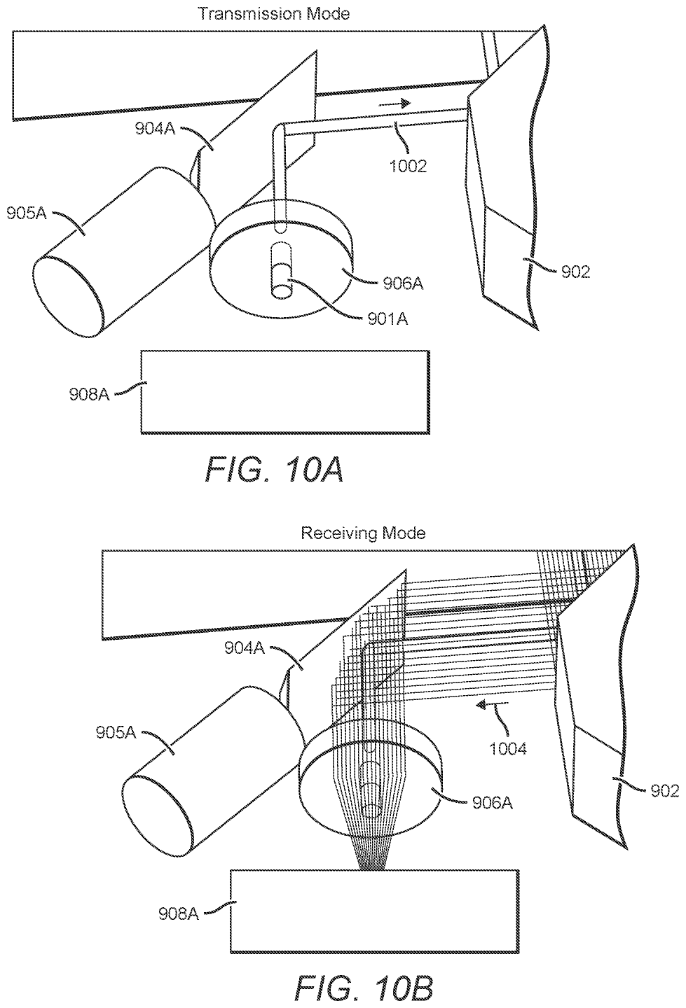

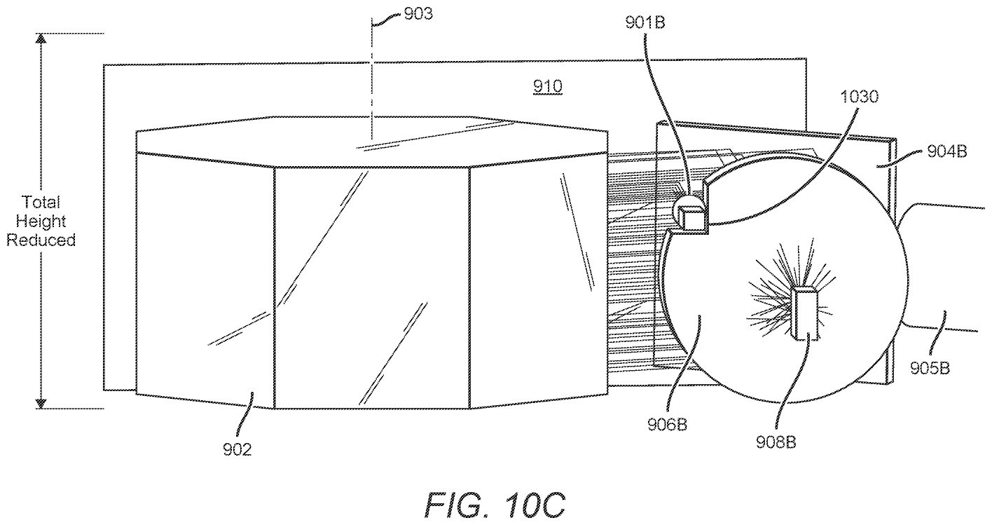

FIG. 10A is a diagram illustrating a portion of the LiDAR system 900 shown in FIG. 9, and an example optical transmission light path in accordance with some embodiments. FIG. 10B is a diagram illustrating a portion of the LiDAR system 900 shown in FIG. 9, and an example optical receiving light path in accordance with some embodiments. The portion of the LiDAR system 900 shown in FIGS. 10A and 10B corresponds to the left portion where oscillating mirror 904A is disposed. But it is understood that similar configurations and operations can be implemented for the right portion of the LiDAR system 900. As illustrated in FIG. 10A, transmitter 901A may be configured to transmit one or more transmission light beams 1002 to polygon mirror 902 via oscillating mirror 904A. Similarly, transmitter 901B may be configured to transmit one or more other transmission light beams to polygon mirror 902 via oscillating mirror 904B (not shown in FIG. 10A). In the configuration shown in FIG. 10A, transmitter 901A may be disposed at least partially inside an opening of a collection lens 906A. In other embodiments, transmitter 901A may be disposed outside of the collection lens 906A. For instance, the transmitter 901A may be disposed upstream of collection lens 906A in the transmission light path while still allowing the transmission light beams to pass through an opening of collection lens 906A. If the transmitter 901A is disposed downstream of collection lens 906A, an opening of collection lens 906A may not be needed. In some examples, the transmitter 901A comprises a fiber array configured to deliver multiple transmission light beams. The fiber array may be coupled to one or more light sources and/or other optics (e.g., a collimation lens) to receive the transmission light beams. Transmitter 901A may also include a collimation lens for collimating the multiple transmission light beams.

FIG. 10B illustrates the receiving light path. As described above, when transmission light beams are scanned to the FOVs, they may be reflected or scattered by objects in the FOVs to form return light. The return light is received by polygon mirror 902 and redirected to oscillating mirrors 904A and 904B, which in turn redirect the return light toward receiver 908A and 908B via collection lens 906A and 906B, respectively. FIG. 10B illustrates a receiving light path at the left portion of the LiDAR system. As shown in FIG. 10B, return light 1004 is directed by a reflective facet of polygon mirror 902 to collection lens 906A via oscillating mirror 904A. Collection lens 906A is configured to have sufficient optical aperture, even with an opening for accommodating transmitter 901A, to collect and focus the return light to receiver 908A. In the embodiment shown in FIG. 10B, the opening of collection lens for accommodating transmitter 901A is positioned at the center of collection lens 906A. As described in more detail below, the opening can also be positioned at another portion of collection lens 906A. The above description of FIGS. 10A and 10B use the optical components located in the left portion of LiDAR system 900 as an example. But it is understood that similar configurations and operations can be implemented for the right portion of the LiDAR system 900.

FIG. 10C is a diagram is a diagram illustrating another example of a portion of the LiDAR system 900 shown in FIG. 9, in accordance with some embodiments. The portion of the LiDAR system 900 shown in FIG. 10C corresponds to the right portion shown in FIG. 9. But it is understood that the configuration shown in FIG. 10C can also be implemented for the left portion of system 900. The portion of system 900 shown in FIG. 10C includes polygon mirror 902, oscillating mirror 904B and its motor 905B, transmitter 901B, collection lens 906B, and a window 910. Similar as described above, polygon mirror 902 and oscillating mirror 904B, in combination, can scan light both horizontally and vertically to an FOV. For instance, polygon mirror 902 can scan light in the horizontal direction and oscillating mirror can scan light in the vertical direction. In the example shown in FIG. 10C, each of the reflective facets of polygon mirror 902 has an orientation substantially parallel to a rotation axis 903 of the polygon mirror 902. FIG. 10C illustrates that light can be passed between the polygon mirror 902 and other optical components in a substantially horizontal direction. As a result, the other optical components (e.g., oscillating mirror 904A) can be disposed on the side of polygon mirror 902, thereby forming a lateral arrangement.

With reference still to FIG. 10, oscillating mirror 904B can be a galvanometer mirror operated by a motor 905B positioned adjacent to mirror 904B in a lateral manner as shown in FIG. 10. For example, the motor 905B may be positioned laterally next to mirror 904B such that it does not increase the overall height of at least the portion of LiDAR system 900 shown in FIG. 10C. As described above, in some embodiments, a lateral arrangement of the components of system 900 can reduce the overall height. For instance, as shown in FIG. 10C, polygon mirror 902 and oscillating mirror 904B are arranged side-by-side rather than being vertically stacked. In addition, the collection lens 906B is also positioned laterally with respect to polygon mirror 902 and oscillating mirror 904B. In one embodiment, collection lens 906B has a notch or opening 1030 configured to accommodate at least a part of transmitter 901B. Unlike FIG. 10B, FIG. 10C illustrates that the notch or opening 1030 is located proximate to an edge or a corner (e.g., top left corner) of collection lens 906B. The notch or opening 1030 can also be disposed at, or approximate to, any edge, corner, center, or any other positions of the collection lens 906B (e.g., in the top middle part of the collection lens 906B, or external to collection lens 906B). The opening or notch 1030 has a dimension configured based on an optical receiving aperture requirement. If the dimension of opening or notch 1030 is too big, it may negatively affect the performance of the collection lens 906B. If it is too small, the transmitter 901B (e.g., a fiber array) may not be able to fit in. For instance, the size of the opening or notch 1030 can be selected such that collection lens 906B has an optical receiving aperture sufficient to detect a 10% reflectivity target located at 200 meters or 250 meters distance, or at a longer distance. In some embodiment, the optical receiving aperture the collection lens 906B may be configured based on a receiving performance between 0.5 and 500 meters, inclusive. Thus, the dimensions of the collection lens 906B and opening/notch 1030 can be selected based on the receiving aperture requirements. In some examples, collection lens 906B is a low-profile collection lens that reduces the height of the system 900 while maintaining a sufficient optical receiving aperture (e.g., an aperture for detecting 10% reflectivity target at 200 m distance).

Through the notch or opening 1030, transmitter 901B emits one or more light beams toward oscillating mirror 904B. Transmitter 901B may include a multiple-channel transmitter (e.g., a transmitter fiber array) that is at least partially disposed within the notch or opening 1030 to deliver light beams to oscillating mirror 904B. The size and position of the notch or opening 1030 can be configured based on the receiving performance requirements or the detection range requirements (e.g., detection of 2 m to 200 m). As described above, oscillating mirror 904B may oscillate to facilitate scanning of the light beams in one direction (e.g., the vertical direction). The light beams are redirected by the oscillating mirror 904B to polygon mirror 902, which is configured to scan the light beams in another direction (e.g., the horizontal direction). The polygon mirror 902 further scans the light beams to an FOV through window 910.

With reference to both FIGS. 9 and 10C, in some embodiments, the LiDAR system 900 comprises one or more windows (e.g., window 910 shown in FIGS. 9 and 10C) forming a portion of an exterior surface of a housing of the system 900. Light can pass through window 910. In some examples shown in FIG. 10C, window 910 is substantially parallel to the rotational axis 903 of polygon mirror 902 or other optics. In other examples, a window may also be tilted at an angle with respect to the at least one of the polygon mirror 902, the oscillating mirror 904B, collection lens 906B, etc. In one embodiment, a window of a LiDAR system may include an antireflection coating.

As described above, polygon mirror 902 scans transmission light beams to an FOV to illuminate one or more objects in the FOV. The transmission light beams may be scattered and/or reflected by objects in the FOV to form return light. The return light travels back through window 910 and is received by polygon mirror 902. The return light is then redirected by one or more reflective surfaces of polygon mirror 902 to oscillating mirror 904B. In turn, oscillating mirror 904B redirects the return light to collection lens 906B, which collects the return light and passes it to receiver 908B. In some embodiments, receiver 908B may include one or more receiving fiber arrays coupled to collection lens 906B. The receiving fiber arrays can deliver the return light to one or more light detectors and/or other receiving components (e.g., mirrors, prisms, fibers, ADC, APD, etc.) for detecting and processing the return light. The receiver 908B can be positioned downstream from the collection lens 906B in the receiving optical path. For instance, when receiver 908B includes one or more receiving fiber arrays, at least one of the one or more receiving fiber arrays can be located adjacent to a back side of the collection lens 908B to receive return light collected by collection lens 906B, and deliver the return light to other components for further processing. In some embodiments, the receiver 908B further comprises one or more optical detectors coupled to the receiving fiber arrays. The optical detectors can be configured to detect the return light and convert the return light to electrical signals. In some embodiments, receiver 908B includes an optical detector array optically coupled to collection lens 906B and/or one or more other collection lens (not shown in FIG. 10C). Therefore, an optical detector array can be used for detecting return light collected by multiple collection lens associated with multiple light steering devices.

In the above description, the combination of polygon mirror 902 and oscillating mirror 904B, when moving with respect to each other, steers light both horizontally and vertically to illuminate one or more objects in an FOV of the LiDAR system; and obtains return light formed based on the illumination of the one or more objects. This type of configuration thus uses the optical scanners (e.g., comprising a polygon mirror 902 and an oscillating mirror 904B) for both steering light out to the FOV and directing return light to collection lens and the receiver. This type of configuration is therefore referred to as the co-axial configuration, indicating that the transmitting light path and the receiving light path are co-axial or at least partially overlap. Similarly, polygon mirror 902 and oscillating mirror 904 also form a co-axial configuration for the left portion of the LiDAR system 900. A co-axial configuration eliminates or reduces redundant optical components, thereby making the LiDAR system more compact and improving the efficiency and reliability of the optical core assembly.

In the lateral arrangement shown in FIG. 10C, the overall height of the portion of the LiDAR system depends on the maximum height of polygon mirror 902, transmitter 901B, collection lens 906B, oscillating mirror 904B and its motor 905B, and receiver 908B, and window 910. For example, because these components are arranged laterally, the overall height of this portion of LiDAR system 900 may be the same or substantially the same as the height of the polygon mirror 902 (or whichever component has the maximum height). As a result, the overall height of the system 900 may be reduced or minimized. The reduced height makes it easier for system 900 to be integrated into, or mounted to, a moveable platform such as a vehicle shown in FIG. 7A.

As described above in connection with FIGS. 7A-7D, in some embodiments, a LiDAR system mounted to a moveable platform (e.g., a vehicle) may have a portion that protrudes outside of the planar surface of the roof of the moveable platform. The portion of the system that protrudes outside of the planar surface of the roof of the moveable platform may protrude in a vertical direction by an amount corresponding to a lateral arrangement of the LiDAR system. The LiDAR system may include a polygon mirror, a plurality of oscillating mirrors, transmitter, receiver, and other optic components. Therefore, reducing the overall height of the LiDAR system can reduce the protrusion of the system outside of the moveable platform.

In some examples, the amount of protrusion of the LiDAR system outside of a moveable platform is determined based on vehicle aerodynamic requirements and/or the optical scanning requirements. From the vehicle aerodynamic aspect, the amount of protrusion should ideally be minimized to near zero. Nonetheless, in some examples, reducing the height of the LiDAR system too much may negatively affect the optical scanning performance of the LiDAR system. Thus, the overall height of the LiDAR system, and in turn the amount of the protrusion, can be determined based on both requirements. Reducing the vertical height of the LiDAR system may expand the overall dimension in the lateral direction, because components of the LiDAR system are arranged side by side in a lateral manner, therefore expanding the lateral dimension. In general, the lateral dimension of the LiDAR system may not be limited because the moveable platform may have sufficient space in the lateral dimension. In other examples, if a space for accommodating the LiDAR system is laterally limited, the overall height of the LiDAR system may not be reduced or reduced much. In general, if the LiDAR system is mounted to the roof of the moveable platform, it is at least partially integrated with a planar surface of the roof. Therefore, whether the overall height of the LiDAR system needs to be reduced depends on the integration manner (e.g., protruded outside of the roof or fully embedded), mounting positions, the aerodynamic requirements, and the optical scanning performance requirements.

The above description for FIG. 10C uses the right portion of LiDAR system 900 as an example. It is understood that similar configurations can be implemented for the left portion of LiDAR system 900. Thus, the LiDAR system 900 shown in FIG. 9 can have lateral arrangements of the components for both left and right portions, for reducing the overall height of the system.

With reference back to FIG. 9, the example embodiment of system 900 comprises two separate transmitters 901A and 901B, and two separate receivers 908A and 908B. In other embodiments, a single transmitter may be used to provide transmission light beams to both sides of the system 900 (e.g., to both oscillating mirrors 904A and 904B). For instance, a fiber-based light source can be used to emit one or more light beams, which can be delivered to both sides of the system 900 using fiber arrays and fiber connectors. On the receiver side, when collection lens 906A and 906B receive return light on both sides of system 900, the return light can be coupled into fiber arrays and delivered to a detector array or multiple detector elements of a detector board. These alternative configurations of transmitters and receivers may further reduce the number of components, and thus make the system 900 more compact. In other embodiments, it may be desirable to keep the detectors separate for receiving and processing the return light from both sides of system 900, for the purpose of reducing interference and optical crosstalk.

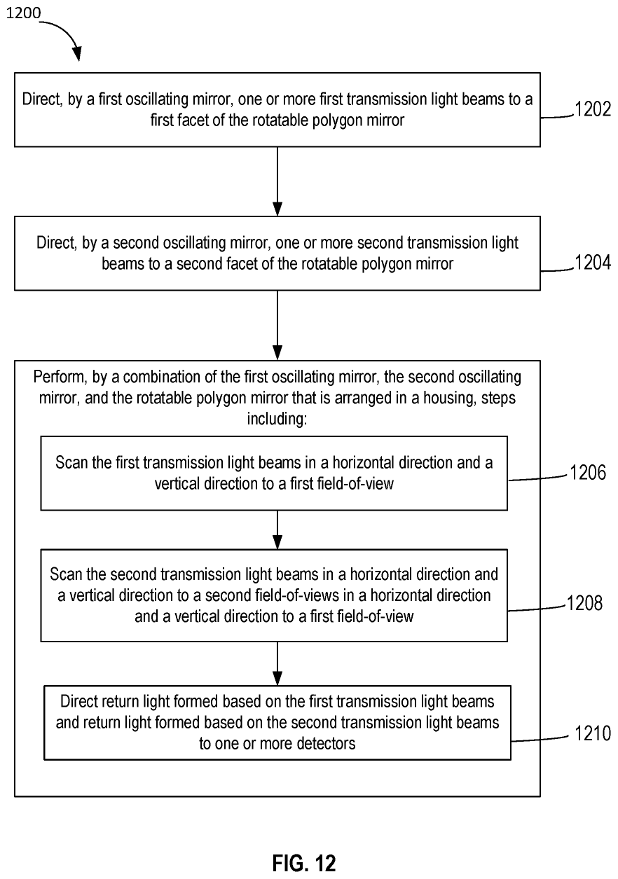

FIG. 12 is a flowchart illustrating a method 1200 performed by a low-profile LiDAR system for scanning FOVs, in accordance with some embodiments. Method 1200 can be performed by, for example, LiDAR system 900 described above. The low-profile LiDAR system may include a rotatable polygon mirror having a plurality of reflective facets, a first oscillating mirror disposed laterally on one side of the rotatable polygon mirror, and a second oscillating mirror disposed laterally on another side of the rotatable polygon mirror. In step 1202 of method 1200, the first oscillating mirror directs one or more first transmission light beams to a first facet of the rotatable polygon mirror. In step 1204, the second oscillating mirror directs one or more second transmission light beams to a second facet of the rotatable polygon mirror. The second facet is different from the first facet. The transmitting light path is illustrated in FIGS. 9 and 10A. For example, a first transmitter can direct the one or more first transmission light beams to the rotatable polygon mirror via the first oscillating mirror; and a second transmitter can direct the one or more second transmission light beams to the rotatable polygon mirror via the second oscillating mirror.

In some embodiments, at least one of a height of the combination of the first oscillating mirror, the second oscillating mirror, and the rotatable polygon mirror; a height of the rotatable polygon mirror; or a height of the housing is no more than approximately 40 mm. As described above, the reduced height is oftentimes desirable for aerodynamic reasons.

In some embodiments, the controlling of the first oscillating mirror and the second oscillating mirror may be independent or synchronized, depending on the scanning requirements.

With reference still to FIG. 12, the combination of the first oscillating mirror, the second oscillating mirror, and the rotatable polygon mirror may be arranged in a housing, and may perform steps 1206, 1208, and 1210. In step 1206, the combination scans the first transmission light beams in a horizontal direction and a vertical direction to a first field-of-view. In step 1208, the combination scans the second transmission light beams in a horizontal direction and a vertical direction to a second field-of-view. The second field-of-view partially overlaps with the first field-of-view.

In step 1210, the combination directs return light formed based on the first transmission light beams and return light formed based on the second transmission light beams to one or more detectors. In particular, the first oscillating mirror directs the return light formed based on the first transmission light beams to a first collection lens; and the second oscillating mirror directs the return light formed based on the second transmission light beams to a second collection lens.

In one embodiment, the first collection lens comprises a first opening and at least a portion of the first transmitter is disposed in the first opening; and the second collection lens comprises a second opening and at least a portion of the second transmitter is disposed in the second opening.

When the return light is directed to the one or more detectors, the detectors detect the return light formed based on the first transmission light beams and the return light formed based on the second transmission light beams. The detectors may comprise, for example, a detector array disposed on a detector board.

In some embodiments, the first transmission light beams and the second transmission light beams are both transmitted through a window toward external of the LiDAR system. The return light is thus received from external of the LiDAR system and through the window. The return light includes both the return light formed based on the first transmission light beams and the return light formed based on the second transmission light beams.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A low-profile light ranging and detection (LiDAR) system, the system comprising:
a housing;
a rotatable polygon mirror having a plurality of reflective facets;
a first oscillating mirror disposed laterally on one side of the rotatable polygon mirror, the first oscillating mirror being configured to direct one or more first transmission light beams to a first reflective facet of the rotatable polygon mirror; and
a second oscillating mirror disposed laterally on another side of the rotatable polygon mirror, the second oscillating mirror being configured to direct the one or more second transmission light beams to a second reflective facet of the rotatable polygon mirror, the second reflective facet being different from the first reflective facet;
wherein a combination of the first oscillating mirror, the second oscillating mirror, and the rotatable polygon mirror is arranged in the housing and configured to:
scan the first transmission light beams in a horizontal direction and a vertical direction to a first field-of-view,
scan the second transmission light beams in a horizontal direction and a vertical direction to a second field-of-view, the second field-of-view at least partially overlapping with the first field-of-view in the horizontal direction, and
direct return light formed based on the first transmission light beams and return light formed based on the second transmission light beams to one or more detectors.

2. The system of claim 1, wherein at least one of a height of the combination, a height of the rotatable polygon mirror, or a height of the housing is no more than 40 mm.

3. The system of claim 1, wherein the rotatable polygon mirror comprises five or more reflective facets.

4. The system of claim 1, wherein the rotatable polygon mirror comprises eight reflective facets.

5. The system of claim 1, wherein the plurality of reflective facets of the rotatable polygon mirror are substantially parallel to the rotational axis of the rotatable polygon mirror.

6. The system of claim 1, wherein a rotational speed of the rotatable polygon mirror is configured based at least on a total number of the plurality of reflective facets of the rotatable polygon mirror and a scan density requirement associated with at least one of the first field-of-view, the second field-of-view, or an area of overlapping between the first field-of-view and the second field-of-view.

7. The system of claim 6, wherein the rotational speed of the rotatable polygon mirror required to reach a pre-determined point density is less than that of a second rotatable polygon mirror of a second LiDAR system comprising the second rotatable polygon mirror and only one oscillating mirror.

8. The system of claim 1, wherein horizontal positions of the first oscillating mirror, the second oscillating mirror, and the rotatable polygon mirror are arranged such that the first field-of-view and the second field-of-view overlap by approximately 40 degrees horizontally.

9. The system of claim 1, wherein the first oscillating mirror and the second oscillating mirror are independently or synchronously controlled.

10. The system of claim 1, further comprising:
a first transmitter configured to direct the one or more first transmission light beams to the rotatable polygon mirror via the first oscillating mirror;
a second transmitter configured to direct the one or more second transmission light beams to the rotatable polygon mirror via the second oscillating mirror.

11. The system of claim 10, further comprising a first collection lens and a second collection lens, wherein:
the first oscillating mirror is configured to direct the return light formed based on the first transmission light beams to the first collection lens, and
the second oscillating mirror is configured to direct the return light formed based on the second transmission light beams to the second collection lens.

12. The system of claim 11, wherein at least one of:
the first collection lens comprises a first opening and at least a portion of the first transmitter is disposed in the first opening; and
the second collection lens comprises a second opening and at least a portion of the second transmitter is disposed in the second opening.

13. The system of claim 12, wherein at least one of:
the first opening is disposed at, or approximate to, an edge, a corner, or a center of the first collection lens;
the second opening is disposed at, or approximate to, an edge, a corner, or a center of second collection lens.

14. The system of claim 10, wherein the first transmitter comprises a first fiber array configured to transmit the one or more first transmission light beams; and the second transmitter comprises a second fiber array configured to transmit the one or more second transmission light beams.

15. The system of claim 1, wherein the one or more detectors are configured to detect the return light formed based on the first transmission light beams and the return light formed based on the second transmission light beams.

16. The system of claim 1, further comprising a window configured to facilitate:
transmitting both the first transmission light beams and the second transmission light beams toward external of the LiDAR system; and
receiving, from external of the LiDAR system, both the return light formed based on the first transmission light beams and the return light formed based on the second transmission light beams.

17. A method performed by a low-profile light ranging and detection (LiDAR) system comprising a rotatable polygon mirror having a first reflective facet and a second reflective facet, a first oscillating mirror disposed laterally on one side of the rotatable polygon mirror, and a second oscillating mirror disposed laterally on another side of the rotatable polygon mirror, the method comprising:
directing, by the first oscillating mirror, one or more first transmission light beams to the first reflective facet of the rotatable polygon mirror; and
directing, by the second oscillating mirror, one or more second transmission light beams to the second reflective facet of the rotatable polygon mirror, the second facet being different from the first facet;
performing, by a combination of the first oscillating mirror, the second oscillating mirror, and the rotatable polygon mirror that is arranged in a housing, steps including:
scanning the first transmission light beams in a horizontal direction and a vertical direction to a first field-of-view,
scanning the second transmission light beams in a horizontal direction and a vertical direction to a second field-of-view, the second field-of-view partially overlapping the first field-of-view, and
directing return light formed based on the first transmission light beams and return light formed based on the second transmission light beams to one or more detectors.

18. The method of claim 17, wherein at least one of a height of the combination, a height of the rotatable polygon mirror, or a height of the housing is no more than 40 mm.

19. The method of claim 17, further comprising controlling the first oscillating mirror and the second oscillating mirror independently or synchronously.

20. The method of claim 17, further comprising:
directing, by a first transmitter, the one or more first transmission light beams to the rotatable polygon mirror via the first oscillating mirror;
directing, by a second transmitter, the one or more second transmission light beams to the rotatable polygon mirror via the second oscillating mirror.

21. The system of claim 20, further comprising:
directing, by the first oscillating mirror, the return light formed based on the first transmission light beams to a first collection lens; and
directing, by the second oscillating mirror, the return light formed based on the second transmission light beams to a second collection lens.

22. The method of claim 21, wherein at least one of:
the first collection lens comprises a first opening and at least a portion of the first transmitter is disposed in the first opening; and
the second collection lens comprises a second opening and at least a portion of the second transmitter is disposed in the second opening.

23. The method of claim 17, further comprising:
detecting, by the one or more detectors, the return light formed based on the first transmission light beams and the return light formed based on the second transmission light beams.

24. The method of claim 17, further comprising:
transmitting both the first transmission light beams and the second transmission light beams through a window toward external of the LiDAR system; and
receiving, from external of the LiDAR system and through the window, both the return light formed based on the first transmission light beams and the return light formed based on the second transmission light beams.

25. A vehicle comprising a low-profile light ranging and detection (LiDAR) system, the system comprising:
a housing;
a rotatable polygon mirror having a plurality of reflective facets;
a first oscillating mirror disposed laterally on one side of the rotatable polygon mirror, the first oscillating mirror being configured to direct one or more first transmission light beams to a first reflective facet of the rotatable polygon mirror; and
a second oscillating mirror disposed laterally on another side of the rotatable polygon mirror, the second oscillating mirror being configured to direct the one or more second transmission light beams to a second reflective facet of the rotatable polygon mirror, the second reflective facet being different from the first reflective facet;
wherein a combination of the first oscillating mirror, the second oscillating mirror, and the rotatable polygon mirror is arranged in the housing and configured to:
scan the first transmission light beams in a horizontal direction and a vertical direction to a first field-of-view,
scan the second transmission light beams in a horizontal direction and a vertical direction to a second field-of-view, the second field-of-view at least partially overlapping with the first field-of-view in the horizontal direction, and
direct return light formed based on the first transmission light beams and return light formed based on the second transmission light beams to one or more detectors.
